(19) United States
(12) Patent Application Publication
(10) Pub. No.: US 2017/0004012 A1
(43) Pub. Date: Jan. 5, 2017

(54) METHODS AND APPARATUS TO MANAGE OPERATIONS SITUATIONS IN COMPUTING ENVIRONMENTS USING PRESENCE PROTOCOLS

(71) Applicant: VMware, Inc., Palo Alto, CA (US)

(72) Inventors: Richard Brian Brown, Colorado Springs, CO (US); Gregory A. Frascadore, Colorado Springs, CO (US)

(21) Appl. No.: 14/755,949

(22) Filed: Jun. 30, 2015

(51) Int. Cl. G06F 9/50; G06F 11/30; G06F 11/34

(52) U.S. Cl. CPC G06F 9/5011; G06F 11/3414; G06F 11/3024

(57) ABSTRACT

Methods, apparatus, systems and articles of manufacture are disclosed to manage operations situations in computing environments using presence protocols. An example method includes determining monitoring information of a resource managed by a management application in the computing environment. The example method also includes comparing the monitoring information to a policy associated with the resource, and, in response to the comparison, posting an alert message to a situation stream in communication with the management application, the alert message to include an identifier associated with the resource.

### FIELD OF THE DISCLOSURE

This disclosure relates generally to virtual computing environments, and, more particularly, to manage operations situations in computing environments using presence protocols.

### BACKGROUND

Virtualizing computer systems provides benefits such as the ability to execute multiple computer systems on a single hardware computer, replicating computer systems, moving computer systems among multiple hardware computers, and so forth. Example systems for virtualizing computer systems are described in U.S. patent application Ser. No. 11/903,374, entitled “METHOD AND SYSTEM FOR MANAGING VIRTUAL AND REAL MACHINES,” filed Sep. 21, 2007, and granted as U.S. Pat. No. 8,171,485, U.S. Provisional Patent Application No. 60/919,965, entitled “METHOD AND SYSTEM FOR MANAGING VIRTUAL AND REAL MACHINES,” filed Mar. 26, 2007, and U.S. Provisional Patent Application No. 61/736,422, entitled “METHODS AND APPARATUS FOR VIRTUALIZED COMPUTING,” filed Dec. 12, 2012, all three of which are hereby incorporated herein by reference in their entirety.

“Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Management applications provide administrators visibility into the condition of infrastructures resources in a data center. Administrators can inspect the infrastructure resources, see the organizational relationships of a virtual application, filter log files, overlay events versus time, etc. Situational awareness is an essential quality that an administrator needs to debug an operational issue.

### BRIEF DESCRIPTION OF THE DRAWINGS

FIG. 1 is a block diagram of an example system constructed in accordance with the teachings of this disclosure in which an example collaboration agent facilitates management of operational situations.

FIG. 2 is a block diagram of an example implementation of the example collaboration agent of FIG. 1 constructed in accordance with the teachings of this disclosure.

FIG. 3 depicts an example message exchange between two management applications in communication with the example situation stream of FIG. 1.

FIG. 4 depicts an example message exchange between actants participating in an example situation stream using the collaboration features of the example system of FIG. 1.

FIGS. 5-7 are flowcharts representative of example machine readable instructions that may be executed to implement the example collaboration agent of FIGS. 1 and/or 2.

FIG. 8 is a block diagram of an example processing platform capable of executing the example machine-readable instructions of FIGS. 5, 6 and/or 7 to implement the example collaboration agent of FIGS. 1 and/or 2.

### DETAILED DESCRIPTION

Examples disclosed herein manage operational situations in a virtual computing environment by converting passive resources in the virtual computing resources into active participants in a situation stream. Disclosed examples utilize presence protocols to enable the resources to independently represent their interests in the situation stream. The disclosed methods, apparatus, and systems enable administrators responsible for the upkeep, configuration and reliable operation of the virtual computing environment to better manage operational situations because the resources of the virtual computing environment promote their conditions (e.g., status, errors, information, etc.) in the situation stream rather than waiting passively until an alert triggers or a user inspects the resource.

Virtual computing services enable one or more compute nodes (CN) to be hosted within computing environment. As disclosed herein, a CN is a computing resource (physical or virtual) that may host a wide variety of different applications such as, for example, an email server, a database server, a file server, a web server, etc. CNs include physical hosts (e.g., non-virtual computing resources such as servers, processors, computers, etc.), virtual machines (VM), containers that run on top of a host operating system without the need for a hypervisor or separate operating system, hypervisor kernel network interface modules, etc. In some examples, a CN may be referred to as a data computer end node or as an addressable node.

VMs operate with their own guest operating system on a host using resources of the host virtualized by virtualization software (e.g., a hypervisor, virtual machine monitor, etc.). Numerous VMs can run on a single computer or processor system in a logically separated environment (e.g., separated from one another). A VM can execute instances of applications and/or programs separate from application and/or program instances executed by other VMs on the same computer.

In examples disclosed herein, containers are virtual constructs that run on top of a host operating system without the need for a hypervisor or a separate guest operating system. Containers can provide multiple execution environments within an operating system. Like VMs, containers also logically separate their contents (e.g., applications and/or programs) from one another, and numerous containers can run on a single computer or processor system. In some examples, utilizing containers, a host operating system uses name spaces to isolate containers from each other to provide operating-system level segregation of applications that operate within each of the different containers. This segregation can be viewed as a form of virtualization that isolates different groups of applications that operate in different containers. In some examples, such containers are more lightweight than VMs.

To monitor the operation of a CN, one or more monitoring agents (e.g., a monitoring program, a monitoring command, etc.) are executed by the CN. Information provided by the monitoring agents may be useful in identifying a problem and/or a cause of the problem (e.g., a root cause) with the CN (e.g., a misconfiguration in a database, a program that frequently crashes, etc.). In scenarios where the CN is operating properly, results of the monitoring agents may not be a concern. However, in a time of crisis (e.g., when a server is malfunctioning and/or non-responsive), such monitoring agents can provide useful information for addressing a problem with the CN.

Situational awareness is about knowing what is happening, what can be done, and knowing this information in time to make a difference. Management applications are useful for collecting, filtering, and inspecting properties of their managed resources (e.g., infrastructure resources) in a virtualized computing environment in order to find the root-cause of an operational issue, but that level of technical understanding suppresses awareness of the underlying situation.

Today's computing resource providers (e.g., cloud computing resource providers) may employ multiple different management systems to meet their overall virtual computing environment management goals. Each one of the different management systems may be responsible for tracking a different set of information corresponding to different resources in the virtual computing environment. Management applications, such as Operations Manager and Log Insight, commercially available products from VMWare®, Inc., aggregate, filter and inspect information returned by the managed resources and provide users with visibility into the conditions of the corresponding resources. While different management applications may collect information from the same resources in an environment, the different management applications may filter and inspect aspects of the information. For example, a first management application may be associated with tracking an inventory of physical resources and logical resources in the virtual computing environment, a second management application may be associated with providing real-time log management of events, analytics, etc., a third management application may be associated with providing operational views of trends, thresholds and/or analytics of the virtual computing environment, etc. Each one of the different management applications may utilize a different data organization structure (e.g., a hierarchical tree structure) and/or a different user interface tailored to the particular aspects that the management application is to manage. As such, each one of the different management applications may have different information about the same resource. Therefore, to obtain a global perspective of a virtual computing environment at a particular point (e.g., when an alert issues), a user (e.g., a data center administrator) must search through the different management applications to determine how to proceed. Such a management approach can be inefficient and cumbersome to use.

Some providers attempt to overcome the problems of utilizing multiple management applications by instead using a single interface to present the different aspects managed by the management applications. The singular interfaces of management applications work against situational awareness. While features like analytics and dynamic thresholds work to discover situations, management interfaces suppress the discoveries behind aggregations and choices. Management interfaces are large and opaque to the untrained administrator. Hierarchical resource arrangements organize and manipulate arrays of resources en mass, but situations develop from events happening to individual resources Innovations that colorize resources and annotate them with summary badges are a concession that events are at risk of being obscured by numbers. Similarly, launch-in-context buttons expose the dilemma that management applications are specialized and share different views of the same set of resources in a virtual computing environment.

Unlike prior systems that hide resources within management applications, examples disclosed herein enable resources to report their conditions (e.g., their state information, their properties, etc.) directly into a situation stream. In some examples disclosed herein, resources independently represent their interests by introducing themselves in the situation stream, and providing observations, suggestions and/or news about themselves or related resources. In some examples, a resource introduces itself in the situation stream when the resource is added to an inventory of resources managed by the management application. In some examples, a resource introduces itself when the resource has information to post in the situation stream (e.g., just-in-time presence). In addition, because the situation stream includes resources that autonomously represent their interests and participate in the situation stream, the situation stream scales. Examples disclosed herein enable administrators to directly interact with active resources by utilizing presence protocols such as Jabber or XMPP (Extensible Messaging and Presence Protocol). A presence protocol is a communication protocol to convey presence in social situations. Activity in a presence protocol is presented in a situation stream (sometimes referred to herein as a “stream,” a “forum” a “room” or a “conversation”). Presence protocols enable resources to independently represent themselves in a situation stream by interacting with people (e.g., administrators) and other “actants” in a conference using a simple message interface. Actants listen and react on streams resembling social discussion channels. Rather than passively waiting for an administrator to inquire about a resource, actants report their situations directly into the situation stream using a presence protocol.

As used herein, an “actant” is a non-human social presence in a situation stream that represents a single resource (or multiple resources) in a managed virtual computing environment and that is implemented by a collaboration of management applications. As mentioned above, a resource's state is distributed through one or more management applications. Disclosed examples enable the management applications to collectively post messages in a situation stream on behalf of the resource. As a result, the distributed state information that was previously isolated among the different management applications is presented in a message interface as a conversational workflow. In some such examples, an actant represents the combination, aggregation, etc. of the collective posts about a resource.

Examples disclosed herein facilitate a focused situation stream by limiting the types of messages posted in the situation stream. For example, in contrast to logs which record postings regarding, for example, every event (e.g., alert, error, information or warning) associated with the resources in the virtual computing environment, as disclosed in some examples herein, actants participate in a situation stream to advocate their conditions and to respond to inquiries. In some disclosed examples, actant participation in the situation stream is triggered from fixed situations and/or patterns. For example, an actant may post a discovery message in the situation stream to introduce themselves when they first join the inventory of a management application. As disclosed herein, actants may also post alert messages about themselves upon detecting an anomaly regarding themselves (e.g., when a policy specified for the resource is violated). For example, an operations management application may detect when a dynamic threshold associated with a resource (e.g., storage latency) is crossed.

Disclosed examples also enable an actant to monitor the situation stream and provide information accordingly. For example, an actant may post and/or push a message to report a borderline condition regarding themselves in response to a message posted about a related resource. For example, a first actant (e.g., a virtual machine) may post an alert message in a situation stream (e.g., “ALERT: high dynamic threshold crossed for ‘disk read latency’”). In response to the alert message, a second actant related to the virtual machine (e.g., a hypervisor that provisioned the virtual machine) may post information related to the virtual machine to the situation stream (e.g., trends related to “disk read latency” for the hypervisor). Actants may also post reply messages to a specific inquiry by a user (e.g., an administrator). For example, an administrator accessing the situation stream may request a management application to provide information for an actant (e.g., “show log entries related to ‘disk read latency’”). In some such examples, the corresponding management application posts a response including the collected information related to the actant. For example, a log management application may post log entries related to the actant, an operations management application may post trend graphs related to the actant, etc.

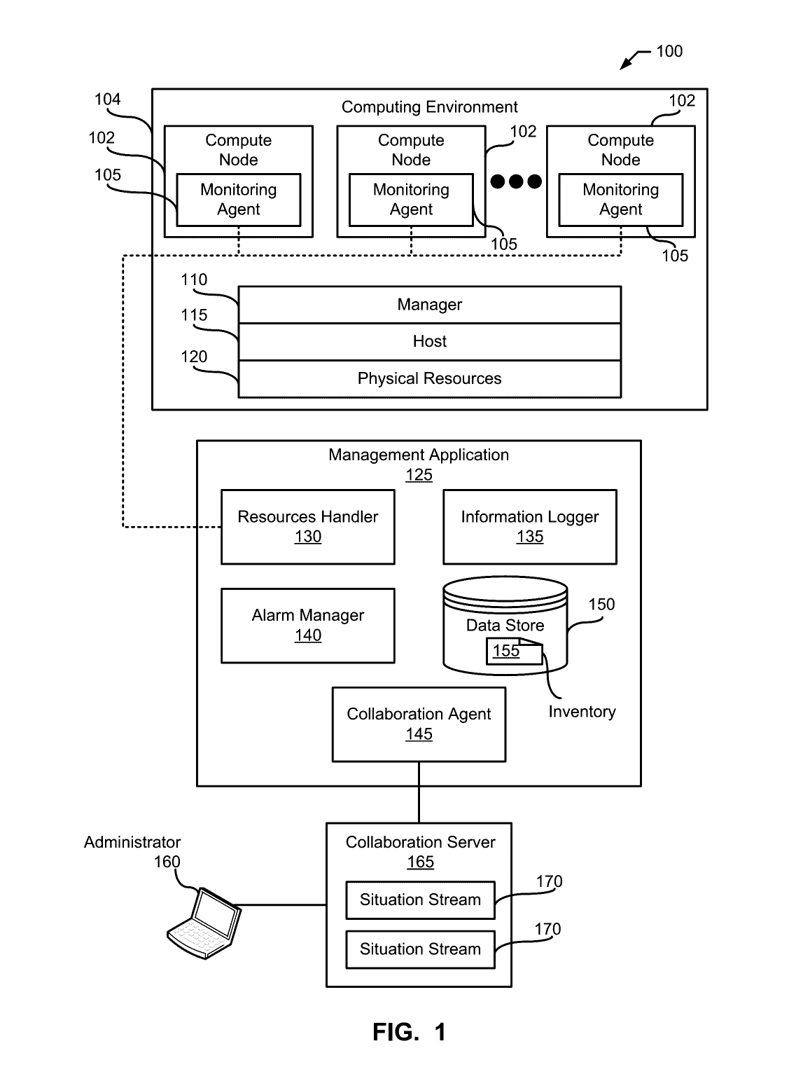

FIG. 1 is a block diagram of an example system 100 constructed in accordance with the teachings of this disclosure in which an example management application 125 facilitates management of operational situations. The example system 100 of FIG. 1 includes an example computing environment 104, the example management application 125 and an example collaboration server 165.

The example computing environment 104 of FIG. 1 (e.g., a virtual computing environment, a distributed deployment, a cloud computing environment, etc.) allows a cluster of physical hosts (e.g., servers) to aggregate computing resources (e.g., processing resources, storage resources, networking resources, etc.) to create a pool of shared computing resources. In the illustrated example of FIG. 1, the example computing environment 104 includes example physical resources 120, an example host 115, an example manager 110 and example CNs 102.

In some examples, the example computing environment 104 of FIG. 1 includes one or more physical machines having the example physical resources 120. In the illustrated example, the host 115 manages the physical resources 120 (e.g., processor(s), memory, storage, peripheral devices, network access, etc.) of the physical machine(s). The example host 115 is a native operating system (OS) executing on the physical resources 120. In the illustrated example of FIG. 1, the host 115 executes the example manager 110. In some examples, the manager 110 is a virtual machine manager (VMM) that instantiates virtualized hardware (e.g., virtualized storage, virtualized memory, virtualized processors(s), etc.) from the underlying physical resources 120. In some examples, the manager 110 is a container engine that enforces isolation of physical resources 120 and/or an environment of the host 115 to isolate the CNs 102. As used herein, isolation means that the container engine manages a first container executing instances of applications and/or programs separate from a second (or other) container for the physical resources 120.

The CNs 102 may include non-virtualized physical hosts, virtual machines (VM), containers (e.g., Docker® containers, etc.), hypervisor kernel network interface modules, etc. The example CNs 102 include an example monitoring agent 105 that executes monitoring operations for their respective CNs 102 to monitor resource utilization (e.g., to identify a level of processor utilization, to identify a level of memory utilization, to identify a network latency of a CN, to identify a query latency of a database hosted by a CN, etc.).

In the illustrated example of FIG. 1, the example CNs 102 execute within the example computing environment 104 managed by the example manager 110. In some examples, one or more of the CNs 102 is a VM executing a guest OS (e.g., a Windows operating system, a Linux operating system, etc.) that accesses virtualized hardware instantiated by the manager 110 (e.g., a VMM, etc.). In some such examples, the one or more of the CNs 102 executes multiple applications and/or services. Additionally or alternatively, in some examples, one or more of the CNs 102 is a container. In some such examples, the one or more of the CNs 102 is isolated (e.g. via name spaces, etc.) by the manager 110 (e.g., a container engine, etc.) from other ones of the CNs 102 executing on the physical resources 120. Typically, such container-based CNs execute a single application and/or service and do not execute a guest OS.

The example monitoring agents 105 are configured with permissions required to monitor the respective one of the CNs 102 in response to a monitoring instruction received from the example management application 125. In response to execution of the monitoring instruction received from the example management application 125, the example monitoring agent 105 reports a result of the executed instruction. In some examples, the monitoring agents 105 execute directly on the CNs 102 (e.g., when the CNs 102 are VMs or non-virtualized physical machines, etc.). In some examples, the monitoring agents 105 execute as part of the manager 110 (e.g., when the CNs 102 are containers, etc.). In some examples, when a monitoring agent 105 is installed on one of the CNs 102, the monitoring agent 105 establishes communication with the example management application 125.

Example methods and apparatus disclosed herein facilitate the management of operational situations in the computing environment 104 by the management application 125 (e.g., vRealize, Log Insight™, and Hyperic®, vSphere®/vCenter™ manager, which are commercially available products from VMWare, Inc.) or similar component. The example management application 125 includes the resources handler 130, an example information logger 135, an example alarm manager 140 and an example collaboration agent 145. The example management application 125 of FIG. 1 also includes an example data store 150.

In the illustrated example of FIG. 1, the management application 125 includes the example resources handler 130 to manage communication with the monitoring agent(s) 105. For example, the resources handler 130 may instruct the monitoring agent(s) 105 to perform monitoring operations. As described above, one or more management applications may be provisioned in the computing environment 104 to collect different monitoring information. For example, a first management application may be associated with tracking an inventory of physical resources and logical resources in the virtual computing environment, a second management application may be associated with providing real-time log management of events, analytics, etc., a third management application may be associated with providing operational views of trends, thresholds and/or analytics of the virtual computing environment, etc. As a result, the monitoring operations that the resources handler 130 instructs the monitoring agent(s) 105 to perform correspond to the type of monitoring information being collected by the management application 125.

In the illustrated example, the resources handler 130 also maintains an inventory 155 of resources available in the computing environment 104. For example, the resources handler 130 may automatically detect new resources available in the computing environment 104 and record the new resource in the inventory 155. In the illustrated example, the resources handler 130 of FIG. 1 stores information that uniquely identifies each of the resources in the computing environment 104 (e.g., resource identifiers “RID(s)”) in the inventory 155. In some examples, the resources handler 130 also stores a unique network address (e.g., an IP address) assigned to each of the managed resources in the inventory 155 along with the respective resource identifying information (e.g., the RID).

In the illustrated example of FIG. 1, the example inventory 155 is a hierarchical structure used by the management application 125 to organize the resources that it manages. For example, the inventory 155 may be a listing of all the resources in the computing environment 104 that were detected by the resources handler 130 and/or the inventory 155 may be a listing of the relationships between the resources. For example, the inventory 155 may identify a virtual machine (e.g., resource identifier “VM01”) that executes a virtual application (e.g., resource identifier “vApp01”), may identify a hypervisor (e.g., resource identifier “esx01”) provisioning the virtual machine (“VM01”), and may identify a physical host (e.g., resource identifier “host01”) providing the hypervisor (“esx01”). In the illustrated example, the inventory 155 is stored in the example data store 150.

In some examples, when a resource identifier (e.g., RID01) and a corresponding unique network address (e.g., IP address01) are stored in the example inventory 155, the example resources handler 130 initiates collecting monitoring information from the resource (e.g., the CN 102) corresponding to the stored resource identifier (e.g., RID01). In the illustrated example, the resources handler 130 collects the monitoring data from the monitoring agents 105 associated with the example resource (e.g., the CN 102). As described above, the example monitoring agent(s) 105 are configured to monitor the performance of a corresponding resource and to report performance information to the management application 125. The example management application 125 uses such performance information to monitor the health of the resources so that corrective action can be taken if, for example, the performance of one or more of the resources begins to degrade, becomes non-responsive, etc.

The example information logger 135 of FIG. 1 logs the monitoring information in the example data store 150. In the illustrated example, the information logger 135 of FIG. 1 logs all monitoring information to the data store 150. However, in some examples, the information logger 135 selectively logs monitoring information. For example, the information logger 135 may log monitoring information when the monitoring information corresponds to an event of interest (e.g., an alert, an error and/or a warning). Selectively logging monitoring information reduces the amount of storage space that is required to store monitoring information that is collected when the CNs 102 are operating properly.

In the illustrated example of FIG. 1, the resources handler 130 supplies the collected monitoring information to the example alarm manager 140 to determine whether the corresponding CNs 102 are maintaining a threshold level of operation. For example, the alarm manager 140 may compare the monitoring information of a CN 102 to a resource policy associated with the CN 102. For example, a policy may specify a maximum storage latency requirement, a minimum storage availability requirement, etc. In this manner, the alarm manager 140 of FIG. 1 warns users (e.g., virtual infrastructure administrators 160) on potential resource over-utilization and/or event conditions. In the illustrated example, the alarm manager 140 of FIG. 1 records alert events (e.g., when the monitoring information does not satisfy a resource policy) and warning events (e.g., when the monitoring information indicates a borderline condition) in the data store 150.

In the illustrated example of FIG. 1, the management application 125 includes the example collaboration agent 145 to facilitate a messaging interface to enable CNs 102 in the computing environment 104 to actively converse with each other. In the illustrated example, the collaboration agent 145 is in communication with an example collaboration server 165 via presence protocol APIs (Application Programming Interface) and/or any other communication protocol. One example implementation of a presence protocol API is XMPP (Extensible Messaging and Presence Protocol).

In the illustrated example, when the collaboration agent 145 is initiated (e.g., at startup of the management application 125), the collaboration agent 145 establishes communication with the collaboration server 165. In some examples, the collaboration agent 145 includes a list of one or more collaboration servers 165 that it may access (e.g., establish a communication with). For example, the list of accessible collaboration servers may include a network address identifying the collaboration server 165. In some examples, the collaboration agent 145 is provided with credentials to access the collaboration server 165. When the collaboration agent 145 is connected to a collaboration server 165 and authenticated, the example collaboration agent 145 of FIG. 1 connects to a situation stream 170 hosted by the collaboration server 165. In some examples, the situation stream 170 is implemented as a messaging interface. Additionally or alternatively, the situation stream 170 may be implemented in any other fashion such as, for example, a web page, a graphical user interface, a file server (e.g., a file transfer protocol (FTP) server), a command line interface, etc.

In the illustrated example of FIG. 1, the collaboration agent 145 monitors the situation stream 170 for key conditions (e.g., an alert message, a message with a resource identifier and/or alert identifier, and/or an inquiry message) and enables posting messages to the situation stream 170. Managed resources (e.g., the CNs 102) participate in the situation stream 170 to advocate their conditions and to respond to inquiries (e.g., from the administrator 160) through the management application 125. For example, the management application 125 posts messages to the situation stream 170 on behalf of a managed resource (e.g., the CNs 102).

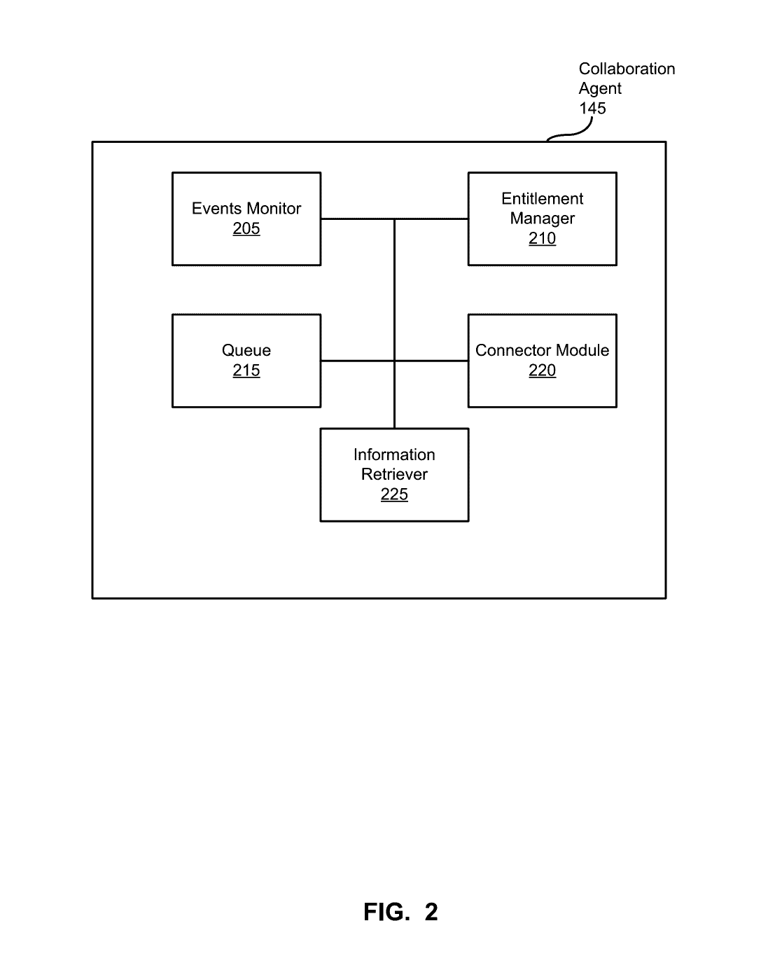

The example collaboration agent 145 of FIG. 1 is implemented as a plug-in to the management application 125. In other examples, the collaboration agent 145 may be implemented as an extension to the management application 125. Additionally or alternatively, the example collaboration agent 145 may be hosted by a dedicated CN 102 (e.g., a virtual machine, a container, etc.), or by one or more management applications 125 managing CNs 102 in the computing environment 104. An example implementation of the example collaboration agent 145 is disclosed in connection with the example of FIG. 2.

In the illustrated example, resources that are online (e.g., participate in the situation stream 170) are referred to as actants. The actants are granted the illusion of presence in the situation stream 170 though postings of the management application 125. That is, when an actant posts in the situation stream 170, it is really the management application 125 posting on their behalf. Moreover, any management application managing a resource in the computing environment 104 is able to post on behalf of the corresponding resource. For example, if a first management application and a second management application collected monitoring information for an example resource (e.g., CN01), the first management application and/or the second management application may post on behalf of the example resource CN01. The collective knowledge and actions of the example management applications grants the illusion of autonomy that converts the passive resource into an actant.

The example data store 150 of FIG. 1 is provided to store the example inventory 155 and/or any other information used by the management application 125 such as configuration information, provisioning information, resource allocation information, etc. For example, the data store 150 may store state information of the CN(s) 102 of the computing environment 104, workload profiles, resource policies, etc. The example data store 150 of FIG. 1 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory)). The example data store 150 may additionally or alternatively be implemented by one or more double data rate (DDR) memories, such as DDR, DDR2, DDR3, mobile DDR (mDDR), etc. The example data store 150 may additionally or alternatively be implemented by one or more mass storage devices such as hard drive disk(s), compact disk drive(s), digital versatile disk drive(s), etc. While, in the illustrated example, the example data store 150 is illustrated as a single database, the example data store 150 may be implemented by any number and/or type(s) of databases.

In the illustrated example of FIG. 1, the example collaboration server 165 is provided to host the example situation streams 170. The example collaboration server 165 receives requests to establish connections from the management application 125 and then verifies the authenticity of the management application 125. In some examples, the collaboration server 165 also verifies whether the management application 125 has privileges to access (e.g., is subscribed to) specific situation streams 170. For example, the collaboration server 165 may host one or more situation streams 170 representative of different characteristics. For example, a first situation stream may be accessible by computing environments that execute a first operating system, a second situation stream may be accessible by computing environments that execute a first hypervisor, etc.

The example collaboration server 165 also receives requests from users (e.g., the administrator 160, etc.) to connect to the situation streams 170. For example, the administrator 160 may connect to a situation stream 170 to monitor the operational situation of the computing environment 104. For example, the collective postings of the participants in the situation stream 170 describe the operational situation of the computing environment 104.

Although the example system 100 includes one computing environment 104, three CNs 102, and one management application 125, the example system 100 is not limited thereto. On the contrary, the example system 100 may include any number of computing environments 104 including any number of CNs 102 in communication with any number of management applications 125.

FIG. 2 is a block diagram of an example implementation of the example collaboration agent 145 of FIG. 1. The example collaboration agent 145 includes an example events monitor 205, an example entitlement manager 210, an example queue 215, an example connector module 220 and an example information retriever 225.

The example events monitor 205 monitors the monitoring information logged by the example information logger 135 (FIG. 1) and detects an event of interest. For example, the events monitor 205 may identify when the information logger 135 logs an alert message, an error message, an informing message and/or a warning message in the example data store 150 (FIG. 1). In such examples, the events monitor 205 selectively filters the types of information posted in the situation stream 170. As a result, the situation stream 170 is not a general log, but, rather, represents information that can enable a user to efficiently and effectively manage an operational situation in the computing environment 104. In addition, the example events monitor 205 may identify events related to when a new resource is added to the inventory 155 maintained by the management application 125.

In the illustrated example of FIG. 2, the example collaboration agent 145 includes the example entitlement manager 210 to arbitrate whether to post the event of interest to the situation stream 170 or to queue the event of interest. The example entitlement manager 210 prevents posting messages in the situation stream 170 when a user with sufficient privileges is not connected to the situation stream 170. For example, the entitlement manager 210 may identify the resource (e.g., the CN 102) that the event of interest pertains to and the event type. The example entitlement manager 210 of FIG. 1 then determines if there is a user (e.g., the administrator 160) connected to the situation stream 170 and if the user is entitled access to the resource and/or event type. For example, the entitlement manager 210 may store entitlement profiles for users that define the events of interest that the user is authorized to access. In the illustrated example, if the entitlement manager 210 determines that the administrator 160 is entitled access to the resource and/or the event type, the entitlement manager 210 confirms that the event of interest can be posted in the situation stream.

In the illustrated example of FIG. 2, if the entitlement manager 210 determines that there is no user connected to the situation stream 170 and/or that a connected user is not entitled access to the resource and/or the event type, the example entitlement manager 210 stores the event of interest in the example queue 215, which includes lists of data, monitoring information, etc. received from the entitlement manager 210. The example queue 215 temporarily stores the lists of data, monitoring information, etc. until a user with acceptable privileges connects to the situation stream 170. Example open standard protocols for message queues, which may be used to facilitate operation of the example queue 215, are the advanced message queueing protocol (AMQP) and the streaming text oriented messaging protocol (STOMP). Different protocols may be used to store messages or information in different ways within example queue 215.

The example connector module 220 interfaces with the collaboration server 165 and/or the situation stream 170. For example, the connector module 220 may initiate a connection with the collaboration server 165 and authenticate its request to connect to the situation stream 170. In the illustrated example, the connector module 220 initiates a connection with the collaboration server 165 by implementing a presence protocol (e.g., XMPP). In the illustrated example, the connector module 220 serves as an interface to access messages posted in the situation stream 170. For example, the connector module 220 can read or pull data from posted messages and/or deliver messages to the situation stream 170. For example, the connector module 220 may post a message that is confirmed by the example entitlement manager 210.

In the illustrated example, the connector module 220 parses a posted message and identifies a resource identifier and/or an event type included in the message. In some examples, when the posted message is a discovery message (e.g., a new resource is introducing itself to the situation stream 170), the connector module 220 updates a list of resources that are participating in the situation stream 170 (e.g., a list of actants).

In the illustrated example, when the posted message is an alert message (e.g., when a property (or properties) of a resource do not satisfy a policy associated with the resource), an informing message and/or a warning message (e.g., when the monitoring information indicates a borderline condition), and/or an inquiry message (e.g., a request for information from the administrator 160), the example connector module 220 notifies the information retriever 225 of the resource identifier and the event type (e.g., type of alert, the borderline condition, and/or the request). In some examples, the connector module 220 posts an acknowledgement message to the situation stream 170 when the connector module 220 forwards the resource identifier and/or the event type to the information retriever 225.

In the illustrated example of FIG. 2, by limiting the information identified by the connector module 220 in a posted message (e.g., the resource identifier and/or the event type), the resources used by the collaboration agent 145 are reduced. For example, the collaboration agent 145 does not need artificial intelligence and/or a natural language processor to participate in the situation stream 170.

The example information retriever 225 of FIG. 2 interfaces with the management application 125. In the illustrated example, the information retriever 225 serves as an interface to retrieve monitoring information from the example data store 150. For example, the information retriever 225 may use the resource identifier provided by the connector module 220 to query the data store 150 for corresponding monitoring information. If the data store 150 returns monitoring information, the example information retriever 225 notifies the entitlement manager 210 to determine whether to post the message to the situation stream 170 or to temporarily store the monitoring information in the example queue 215.

In some examples, the information retriever 225 may query the inventory 155 to determine one or more resources related to the identified resource. For example, the topology of the CNs 102 in the computing environment 104 is typically a hierarchical structure. For example, an application (e.g., identified in the inventory 155 with the resource identifier “vApp01”) may execute on a virtual machine (e.g., identified in the inventory 155 with the resource identifier “VM01”), which may be provisioned by a hypervisor (e.g., identified in the inventory 155 with the resource identifier “esx01”) that is provided a host server (e.g., identified in the inventory 155 with the resource identifier “host01”), and the virtual machine (e.g., “VM01”) may provide storage resources (e.g., identified in the inventory 155 with the resource identifier “nas01”) to the application (e.g., “vApp01”) via an SCSi interface (identified in the inventory 155 with the resource identifier “SCSi01”). In some such examples, performance degradation of one resource may negatively impact one or more of the other related resources. For example, errors for the SCSi01 resource in the nas01 resource may result in increased “disk read latency” for the nas01 resource, which may result in an increased “disk read latency” for the vApp01 resource. In the illustrated example of FIG. 2, if the vApp01 resource posts an alert message in the situation stream 170 (e.g., “Alert: High dynamic threshold crossed for ‘disk read latency’”), the example information retriever 225 retrieves monitoring information for the vApp01 resource (e.g., log entries for “disk read latency” related to the vApp01 resource) and then, using resource identifiers provided by the example inventory 155 for resources related to the vApp01 resource, the information retriever 225 may query the data store 150 for monitoring information related to the VM01 resource, the esx01 resource, the host01 resource, the nas01 resource and/or the SCSi01 resource. The example information retriever 225 then provides any returned monitoring information to the example entitlement manager 210 to determine whether to post the returned monitoring information.

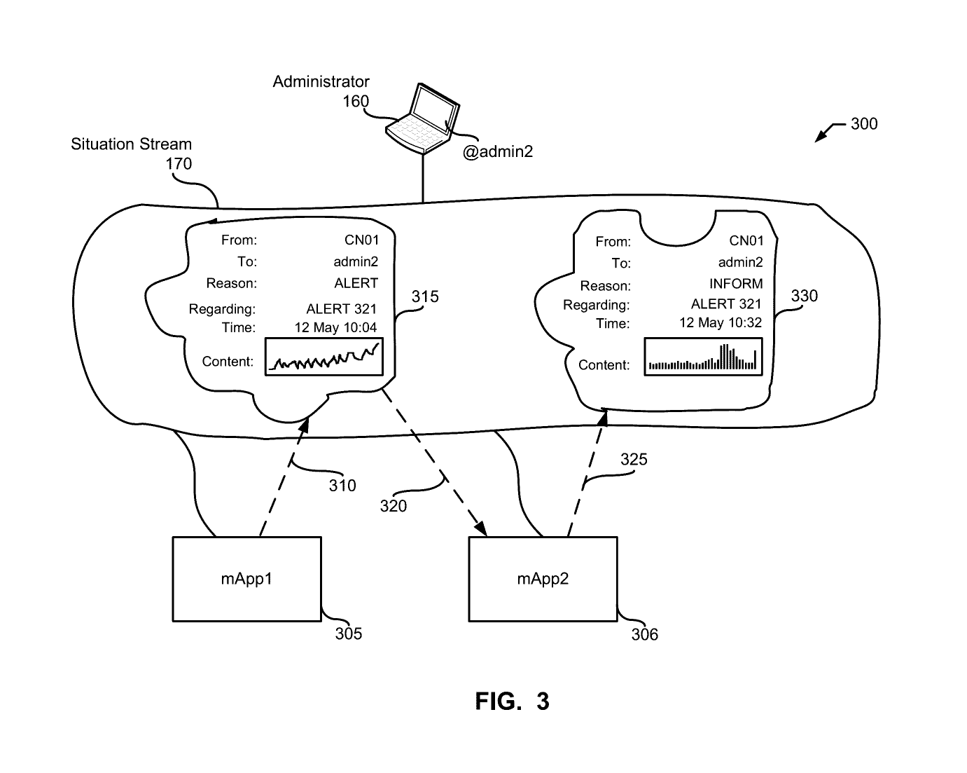

FIG. 3 illustrates an example message exchange 300 between an example first management application 305 (e.g., resource identifier “mApp1”) and an example second management application 306 (e.g., resource identifier “mApp2”) in communication with the example situation stream 170 of FIG. 1. FIG. 3 depicts an example sequence of events that are executed when an alert event is detected by the first management application 305 and the example administrator 160 is online. In the illustrated example of FIG. 3, the first management application 305 posts 310 an example alert message 315 in response to detecting the alert event. For example, the example events monitor 205 (FIG. 2) may detect the alert event for the CN01 resource. In addition, the example entitlement manager 210 (FIG. 2) may arbitrate whether an entitled user is online (e.g., connected to the situation stream 170). For example, the entitlement manager 210 may determine whether an entitlement profile for the online user (e.g., user identifier “admin2”) allows the user to access the resource (e.g., the CN01 resource) and/or alert type. If the entitlement manager 210 determines that the online user is entitled to access the resource and/or alert type identified in the alert message 315, then the example connector module 220 (FIG. 2) posts the alert message 315 to the situation stream 170. The example alert message 315 includes a resource identifier for the actant that posted the message (e.g., “CN01”) and a resource identifier for the online user (e.g., “admin2”). The example alert message 315 also includes a message type (e.g., “ALERT”), which identifies the reason that the message 315 was posted. The example message 315 also includes additional information (e.g., content) collected by the first management application 305. For example, the alert message 315 includes a graph.

In the illustrated example of FIG. 3, the example second management application 306 is monitoring the situation stream 170 for resource identifiers in posted messages to determine whether it can provide pertinent monitoring information. In the illustrated example, the second management application 306 retrieves 320 the resource identifier (e.g., “CN01”) included in the posted message 315. The example second management application 306 then determines whether it has monitoring information that may be pertinent to addressing the operational situation (e.g., the alert event identified by the alert message 315). For example, the example information retriever 225 (FIG. 2) of the second management application 306 may use the resource identifier (e.g., “CN01”) to query its data store 150 (FIG. 1) for pertinent monitoring information.

In the illustrated example of FIG. 3, the example second management application 306 posts 325 an example inform message 330 to the situation stream 170. Similar to the example alert message 315, the inform message 330 includes a resource identifier for the actant that posted the message (e.g., “CN01”), a resource identifier for the online user (e.g., “admin2”), and a message type (e.g., “INFORM”), which identifies the reason that the message 330 was posted to the situation stream 170. The example message 330 also includes additional information (e.g., content) collected by the second management application 306 that may be pertinent to addressing the alert event. For example, the inform message 330 includes a graph.

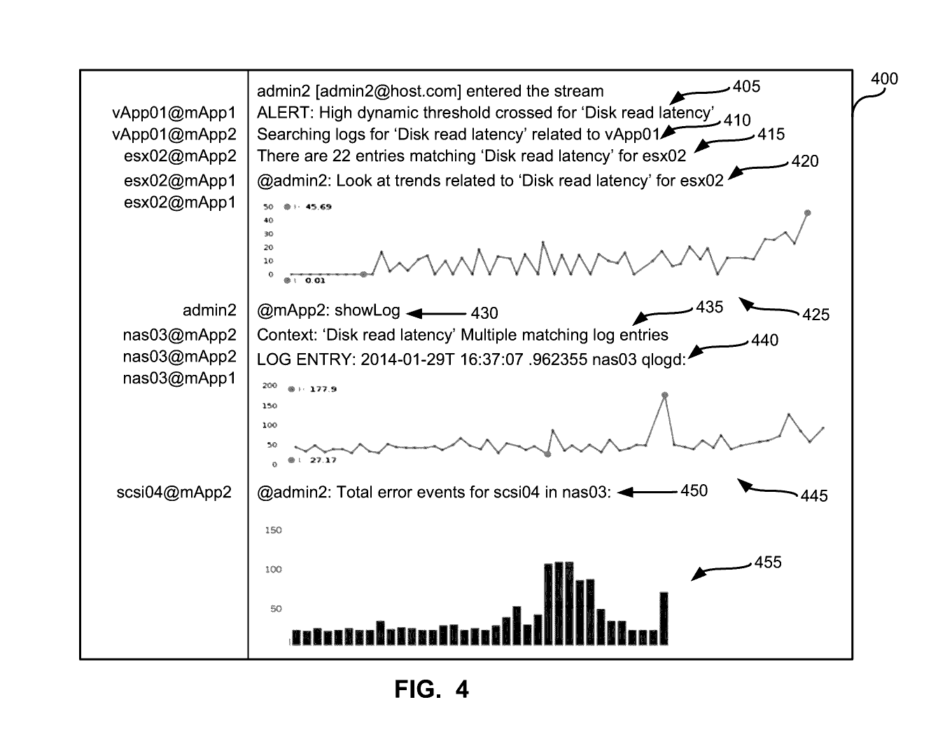

FIG. 4 illustrates an example conversational workflow between example actants vApp01, esx02, nas03, scsi04 and an example administrator 160, admin2. The example actants vApp01, esx02, nas03, scsi04 of FIG. 4 are the online representation of CNs 102 of FIG. 1. FIG. 4 depicts how the example actants vApp01, esx02, nas03, scsi04 process and react to messages posted by other actants and users in an example situation stream 400. In the illustrated example, the vApp01 actant posts an alert message 405 via, for example, the connector module 220 (FIG. 2). In the illustrated example, the alert message 405 includes monitoring information collected by an example first management application (e.g., resource identifier “mApp1”). For example, the first management application (e.g., “mApp1”) may be an operations management application that collects monitoring information pertinent to resource conditions and compliance with resource policies. In the illustrated example of FIG. 4, the example message 405 identifies the message type (e.g., “ALERT”), a resource identifier (e.g., “vApp01”) for the resource associated with the alert event and an alert type (e.g., “disk read latency”).

In response to the message 405, an example second management application (e.g., resource identifier “mApp2”) identifies the resource identifier included in the message 405 (e.g., “vApp1”) and queries its example data store 150 (FIG. 1) for monitoring information pertinent to the alert message 405. For example, the second management application may use the resource identifier (“vApp1”) to query for monitoring information for the resource, and may also query the example inventory 155 (FIG. 1) to determine whether there are resources related to the resource. In the illustrated example of FIG. 4, on behalf of the vApp1 resource, the example second management application (e.g., mApp2) posts message 410 indicating that the second management application (e.g., mApp2) is searching its collected monitoring information for log entries for the alert type “disk read latency” that are related to the vApp1 resource. In the illustrated example, the inventory 155 returns a resource identifier (e.g., “esx02”) related to the original resource identifier (e.g., “vApp1”). For example, the vApp1 resource may execute on a hypervisor (e.g., resource identifier “esx02”). In response to the identified related resource, the example information retriever 225 of the second management application (“mApp2”) queries its data store 150 for monitoring information related to the first related resource identifier (e.g., “esx02”).

In the illustrated example of FIG. 4, the second management application (“mApp2”) posts an inform message 415 indicating that 22 log entries matching the alert type “disk read latency” for the first related resource (“esx02”) were found.

In the illustrated example of FIG. 4, in response to the inform message 415 posted by the second management application (“mApp2”) on behalf of the first related resource (e.g., “esx02”), the example first management application (“mApp1”) queries its data store 150 for monitoring information for the first related resource (e.g., “esx02”). In the illustrated example, the data store 150 of the first management application (“mApp1”) returns monitoring information that may, for example, be more useful presented as a graph. As a result, the example first management application (“mApp1”) posts first inform message 420 and second inform message 425. For example, the first inform message 420 announces that a graph illustrating trends related to “Disk read latency” for the first related resource (“esx02”) is to be posted, and the second inform message 425 presents the graph.

In the illustrated example of FIG. 4, the user (e.g., user identifier “admin2”) posts a specific inquiry message 430 requesting the second management application (“mApp2”) post log entry. In the illustrated example, the second management application (“mApp2”) acknowledges the specific inquiry message 430 by posting reply message 435 identifying, for example, a query term (e.g., “Disk read latency”) used by the example information retriever 225 of the second management application (“mApp2”) to retrieve pertinent monitoring information related to the original resource (e.g., “vApp1”) or to the first related resource (e.g., “esx02”). The example second management application (“mApp2”) then posts a reply message 440 presenting an example log entry. In the illustrated example, the reply messages 435, 440 are posted on behalf of a second related resource (e.g., resource identifier “nas03”). For example, the second related resource (“nas03”) may be a pertinent resource, for example, if the vApp1 resource and/or the esx02 resource utilize storage provided by the second related resource (“nas03”).

In the illustrated example of FIG. 4, in response to the reply messages 435, 440 posted by the second management application (“mApp2”), the example first management application (“mApp1”) posts an inform message 445 with a graph presenting, for example, a spike in the “disk read latency” for the recent past form” monitoring information collected by the first management application (“mApp1”) that corresponds to the second related resource (“nas03”).

In the illustrated example of FIG. 4, in response to the inform message 445, the example second management application (“mApp2”) identifies a third related resource (e.g., resource identifier “scsi04”) and retrieves monitoring information pertinent to the alert message 405 and that is related to the second related resource (“nas03”). In the illustrated example, the pertinent information posted in inform messages 450, 455 is a bar graph presenting the number of error events collected for the third related resource (“scsi04”).

In the illustrated example of FIG. 4, a user (e.g., “admin2”) monitoring the conversational workflow presented in the situation stream 400 learns about an operational situation without user intervention. For example, the example first management application (“mApp1”)) posted an alert message 405 without being prompted by a user. In addition, the conversational workflow presented in the situation stream 400 automatically (e.g., without user intervention) identifies related resources and monitoring information for the related resources that may be pertinent to the user.

While an example manner of implementing the example collaboration agent 145 of FIG. 1 is illustrated in FIG. 2, one or more of the elements, processes and/or devices illustrated in FIG. 2 may be combined, divided, re-arranged, omitted, eliminated and/or implemented in any other way. Further, the example events monitor 205, the example entitlement manager 210, the example queue 215, the example connector module 220, the example information retriever 225 and/or, more generally, the example collaboration agent 145 of FIG. 2 may be implemented by hardware, software, firmware and/or any combination of hardware, software and/or firmware. Thus, for example, any of the example events monitor 205, the example entitlement manager 210, the example queue 215, the example connector module 220, the example information retriever 225 and/or, more generally, the example collaboration agent 145 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example events monitor 205, the example entitlement manager 210, the example queue 215, the example connector module 220, the example information retriever 225 and/or, more generally, the example collaboration agent 145 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example collaboration agent 145 of FIG. 1 may include one or more elements, processes and/or devices in addition to, or instead of, those illustrated in FIG. 2, and/or may include more than one of any or all of the illustrated elements, processes and devices.

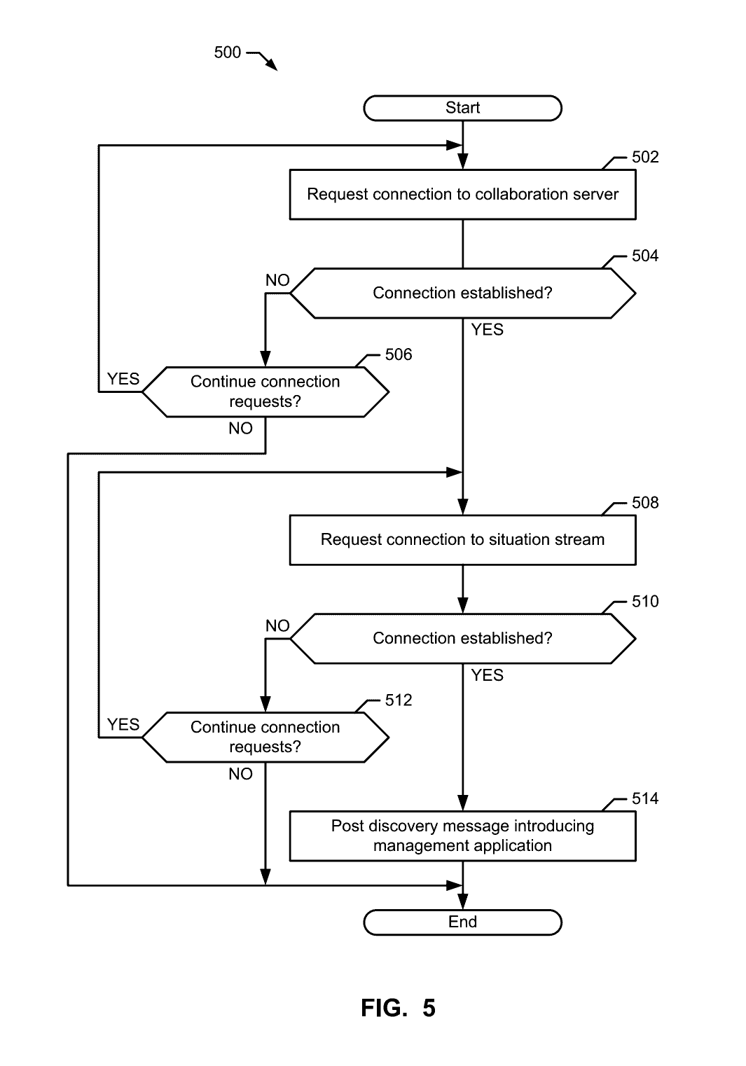

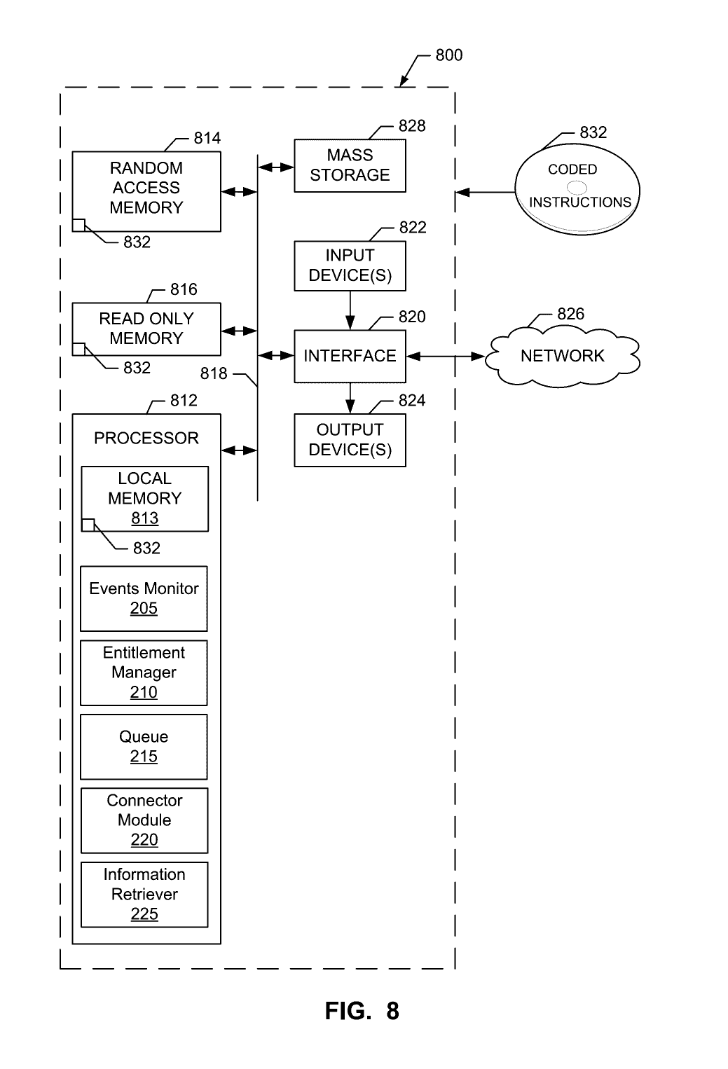

Flowcharts representative of example machine readable instructions for implementing the example collaboration agent 145 of FIGS. 1 and/or 2 are shown in FIGS. 5-7. In these examples, the machine readable instructions comprise programs for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIGS. 5-7, many other methods of implementing the example collaboration agent 145 may alternatively be used. For example, the order of execution of the blocks may be changed, and/or some of the blocks described may be changed, eliminated, or combined.

As mentioned above, the example processes of FIGS. 5-7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended. Comprising and all other variants of “comprise” are expressly defined to be open-ended terms. Including and all other variants of “include” are also defined to be open-ended terms. In contrast, the term consisting and/or other forms of consist are defined to be close-ended terms.

FIG. 5 is a flowchart representative of example machine-readable instructions 500 that may be executed to implement the example collaboration agent 145 of FIGS. 1-3 and/or 4 to initiate the collaboration service in the computing environment 104 of FIG. 1. For example, the collaboration agent 145 may be a plug-in in communication with the example management application 125 (FIG. 1), may be an extension in communication with the example management application 125 and/or may be included with the management application 125, for example, upon startup of the management application 125.

The example instructions 500 of the illustrated example of FIG. 5 begin at block 502 when the example collaboration agent 145 requests to establish a connection with the example collaboration server 165 (FIG. 1). For example, the example connector module 220 may transmit a connection request to a network address (e.g., an IP address) associated with the collaboration server 165. In the illustrated example, the connector module 220 attempts to establish a connection with the collaboration server 165 via XMPP APIs. In some examples, the connector module 220 includes and/or accesses a list of network addresses with which the collaboration agent 145 and the management application 125 are authorized to connect. At block 504, the example connector module 220 determines whether a connection with the collaboration server 165 is established. For example, the collaboration server 165 may transmit an acknowledgement message to the collaboration agent 145 when a connection is established. If, at block 504, the example connector module 220 determined that a connection was not established, then, at block 506, the collaboration agent 145 determines whether to continue attempt(s) to establish a connection with the collaboration server 165.

If, at block 506, the example collaboration agent 145 determined to continue attempt(s) to establish a connection, then control returns to block 502 and the example connector module 220 transmits a connection request to the collaboration server 165. If, at block 506, the example collaboration agent 145 determined not to continue attempts to establish a connection (e.g., in response to a time-out event), then the example program 500 of FIG. 5 ends.

If, at block 504, the example collaboration agent 145 determined that a connection with the collaboration was established (e.g., in response to receiving an acknowledgement message from the collaboration server 165), then, at block 508, the example collaboration agent 145 requests to establish a connection with the example situation stream 170 (FIG. 1). For example, the example connector module 220 may transmit a connection request to a network address (e.g., an IP address) associated with a situation stream 170 provided by the collaboration server 165. In some examples, the connector module 220 includes and/or accesses a list of network addresses associated with situation streams 170 with which the collaboration agent 145 and the management application 125 are authorized to connect. At block 510, the example connector module 220 determines whether a connection with the situation stream 170 is established. For example, the collaboration server 165 may transmit an acknowledgement message to the collaboration agent 145 when a connection is established with the situation stream 170. In some examples, the collaboration server 165 may deny a connection request with the situation stream 170 if, for example, the collaboration agent 145 is not authorized to access the situation stream 170. If, at block 510, the example connector module 220 determined that a connection was not established, then, at block 512, the collaboration agent 145 determines whether to continue attempt(s) to establish a connection with the situation stream 170.

If, at block 512, the example collaboration agent 145 determined to continue attempt(s) to establish a connection with the situation stream 170, then control returns to block 508 and the example connector module 220 transmits a connection request to the situation stream 170. If, at block 512, the example collaboration agent 145 determined not to continue attempts to establish a connection (e.g., in response to a time-out event), then the example program 500 of FIG. 5 ends.

If, at block 510, the example collaboration agent 145 determined that a connection was established with the situation stream 170, then, at block 514, the example collaboration agent 145 posts a discovery message introducing the management application 125 to the participants of the situation stream 170. The example program 500 of FIG. 5 then ends.

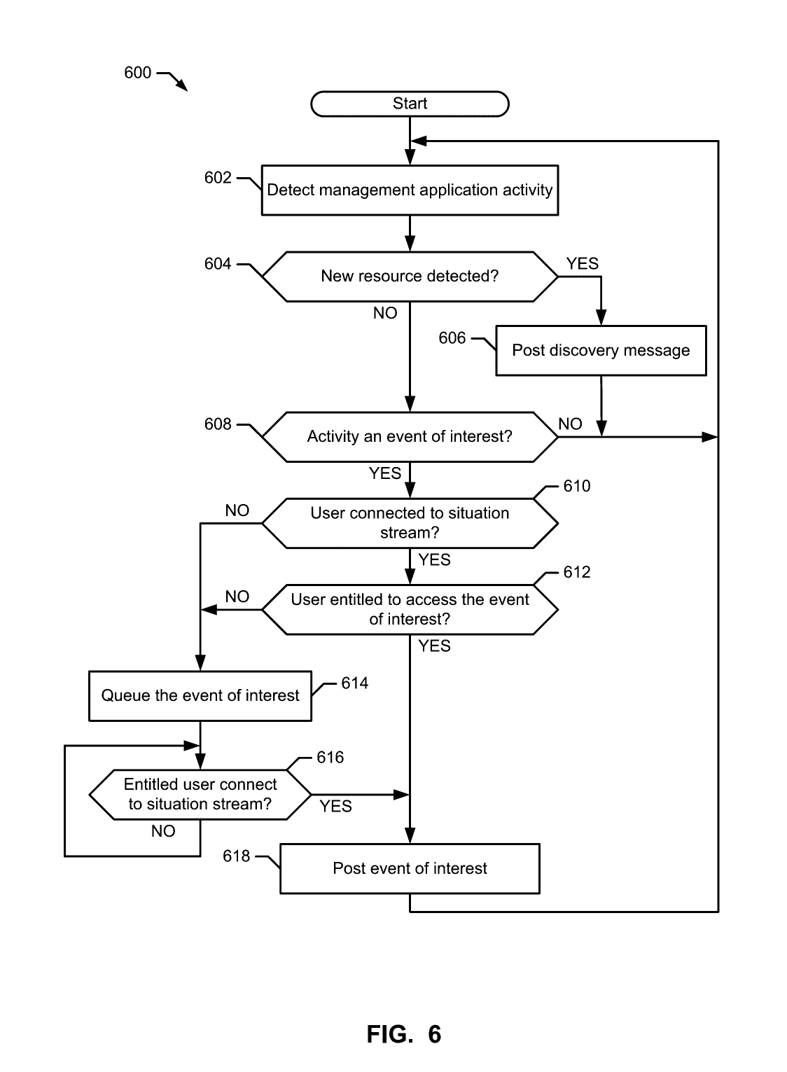

FIG. 6 is a flowchart representative of example machine-readable instructions 600 that may be executed to implement the example collaboration agent 145 of FIGS. 1-3 and/or 4 to post messages to the situation stream 170 (FIG. 1) based on activity detected from the management application 125 (FIG. 1). For example, the collaboration agent 145 may detect monitoring information indicating a new resource (e.g., the example CNs 102 of FIG. 1) was added to the inventory of resources managed by the management application 125 and/or an alert event was detected.

The example instructions 600 of the illustrated example of FIG. 6 begin at block 602 when the example collaboration agent 145 detects management application 125 activity. For example, the example events monitor 205 may identify when the information logger 135 (FIG. 1) logs monitoring information in the example data store 150 (FIG. 1). If, at block 604, the collaboration agent 145 determines that the monitoring information identifies a new resource added to the inventory of resources managed by the management application 125, then, at block 606, the example collaboration manager 145 posts a discovery message to the situation stream 170 introducing the new resource to the participants of the situation stream 170. Control then returns to block 602 to detect activity of the example management application 125.

If, at block 604, the example collaboration agent 145 determined that the monitoring information did not relate to a new resource, then, at block 608, the example collaboration agent 145 determines whether the detected activity was related to an event of interest. For example, the example events monitor 205 may selectively filter monitoring information to post in the situation stream by identifying monitoring information related to an alert event, an error event and/or a warning event. If, at block 608, the events monitor 205 determined that the detected activity of the example management application 125 was not an event of interest, control returns to block 602 to detect management application 125 activity.

If, at block 608, the example collaboration agent 145 determined that the detected activity was an event of interest, then, at block 610, the collaboration agent 145 determines whether a user (e.g., the administrator 160) is connected to the situation stream 170. If, at block 610, the collaboration agent 145 determined that a user was connected to the situation stream 170, then, at block 612, the example collaboration agent 145 determines whether the connected user is entitled to access the event of interest. For example, the entitlement manager 210 may compare access privileges associated with the resource and/or event type corresponding to the event of interest to an entitlement profile defining the events of interest that the user is authorized to access. If, at block 612, the example collaboration agent 145 determined that the connected user was entitled to access the event of interest, then, at block 618, the collaboration agent 145 posts the event of interest in the situation stream 170. For example, the example connector module 220 may deliver an alert message to the situation stream 170. Control then returns to block 602 to detect activity of the example management application 125.

If, at block 610, the collaboration agent 145 determined that a user was not connected to the situation stream 170, or, if, at block 612, the collaboration agent 145 determined that the connected user was not entitled to access the event of interest, then, at block 614, the example collaboration agent 145 queues the event of interest. For example, the entitlement manager 210 may store the event of interest in the example queue 215. For example, rather than post an alert message when a user who can respond to the alert message is not available to respond to the alert message, the example collaboration agent 145 stores the event of interest to post at a later point in time. At block 616, the example collaboration agent 145 determines whether an entitled user connected to the situation stream 170. If, at block 616, the entitlement manager 210 determined that an entitled user was not connected to the situation stream 170, then control returns to block 616 to wait for an entitled user to connect to the situation stream 170.

If, at block 616, the example collaboration agent 145 determined that an entitled user connected to the situation stream 170, then, at block 618, the collaboration agent 145 posts the event of interest in the situation stream 170. For example, the example connector module 220 may retrieve one or more events of interests from the queue 215 to post in the situation stream 170. Control then returns to block 602 to detect activity of the example management application 125.

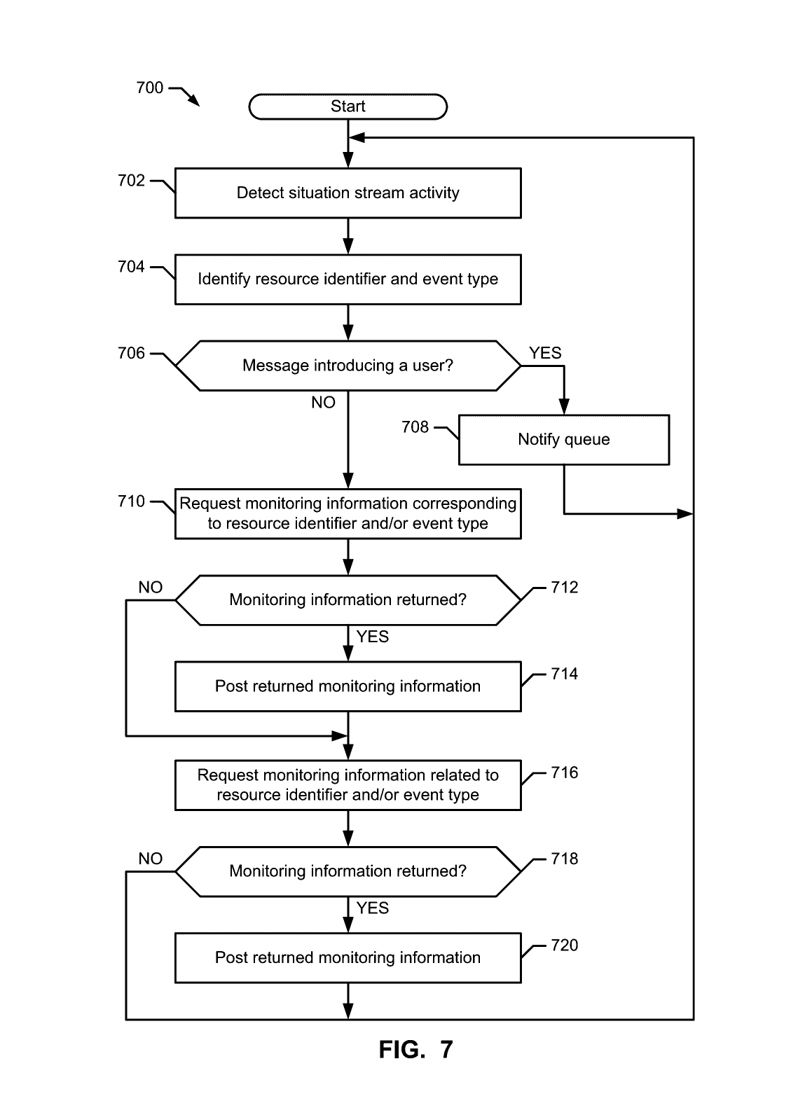

FIG. 7 is a flowchart representative of example machine-readable instructions 700 that may be executed to implement the example collaboration agent 145 of FIGS. 1-3 and/or 4 to monitor an example situation stream 170. For example, the collaboration agent 145 may pull messages posted in the situation stream 170.

The example instructions 700 of the illustrated example of FIG. 7 begin at block 702 when the example collaboration agent 145 detects activity in the situation stream 170. At block 704, the example collaboration agent 145 identifies a resource identifier and an event type associated with the posted message. For example, the example connector module 220 (FIG. 2) may parse the posted message to identify the resource identifier and the event type.

At block 706, the example collaboration agent 145 determines whether the posted message was a discovery message introducing a user (e.g., the example administrator 160). If, at block 706, the example collaboration agent 145 determined that the posted message was introducing a user (e.g., the resource identifier is associated with an administrator and the event type is a discovery message), then, at block 708, the example collaboration agent 145 notifies the example queue 215. As described above, the queue 215 stores events of interest that are not posted (e.g., when a user is not connected to the situation stream, when the connected user is not entitled to access the event of interest, etc.) when the event of interest was detected by the events monitor 205. Control then returns to block 702 to detect activity of the example situation stream 170.

If, at block 706, the example collaboration agent 145 determined that the posted message was not to introduce a user (e.g., the event type of was not a discover message and/or the resource identifier was associated with a CN 102 managed in the computing environment 104), then, at block 710, the example collaboration agent 145 requests monitoring information corresponding to the resource identifier and/or the event type. For example, the example information retriever 225 may use the resource identifier and/or event type to query the data store 150 (FIG. 1) for corresponding monitoring information. If, at block 712, the data store 150 returned monitoring information to the information retriever 225, then, at block 714, the collaboration agent 145 posts the returned monitoring information to the situation stream 170. In some examples, the collaboration agent 145 may provide the returned monitoring information to the entitlement manager 210 to determine whether to post the monitoring information or to queue the monitoring information.

After the collaboration agent 145 posts the returned monitoring information at block 714, or, if, at block 712, the data store 150 did not return monitoring information to the information retriever 225, then, at block 716, the example collaboration agent 145 requests monitoring information related to the resource identifier and/or the event type. For example, the example information retriever 225 may use the resource identifier and/or event type to query the inventory 155 for resource identifiers and/or event types that are related to the original resource identifier and/or the original event type identified by the connector module 220. The example information retriever 225 may then use the related resource identifier(s) and/or the related event type(s) to query the example data store 150 for related monitoring information. If, at block 718, the data store 150 returned monitoring information to the information retriever 225, then, at block 720, the collaboration agent 145 posts the returned monitoring information to the situation stream 170. In some examples, the collaboration agent 145 may provide the returned monitoring information to the entitlement manager 210 to determine whether to post the monitoring information or to queue the monitoring information.

After the collaboration agent 145 posts the returned monitoring information at block 720, or, if, at block 718, the data store 150 did not return monitoring information to the information retriever 225, then control returns to block 702 to detect situation stream 170 activity.

FIG. 8 is a block diagram of an example processor platform 800 capable of executing the instructions of FIGS. 5, 6 and/or 7 to implement the collaboration agent 145 of FIGS. 1 and/or 2. The processor platform 800 can be, for example, a server, a personal computer, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example executes the instructions to implement the example events monitor 205, the example entitlement manager 210, the example queue 215, the example connector module 220, the example information retriever 225 and/or, more generally, the example collaboration agent 145. The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 5, 6 and/or 7 may be stored in the mass storage device 828, in the volatile memory 814, in the non-volatile memory 816, and/or on a removable tangible computer readable storage medium such as a CD or DVD.

From the foregoing, it will appreciate that the above disclosed methods, apparatus and articles of manufacture manage operations situations in computing environments using presence protocols.

The disclosed methods, apparatus and articles of manufacture facilitate detection of conditions in the computing environment before they become problems. For example, actants participating in a situation stream automatically (e.g., without user intervention) present alerts, warning, and/or errors that may be helpful for debugging. In addition, the disclosed methods, apparatus and articles of manufacture provide insight into the manner in which a problem unfolds. For example, by monitoring a situation stream, a user can identify the order conditions become apparent and the affected participants. In some examples, the temporal co-occurrence of different issues in the situation stream may suggest relationships between the issues. For example, if an actant posts an alert message indicating a “disk read latency” alert, and shortly thereafter related actants post inform messages regarding issues they are detecting (e.g., “disk read latency,” “total error events,” etc.), a user may be able to connect the initial alert with the later presented issues and, in addition, address the initial alert by remedying a later presented issue. Moreover, the information presented in the situation stream appears directly in the situation stream without pre-interpretation by the user (e.g., without guessing what and where the issue is) and without having to enter a specific management application user interface that only presents a portion of the total state information for managed resources.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to manage operational situations in a computing environment, the method comprising:
determining monitoring information of a resource managed by a management application in the computing environment;
comparing the monitoring information to a policy associated with the resource; and
in response to the comparison, posting an alert message to a situation stream in communication with the management application, the alert message to include an identifier associated with the resource.

2. A method as defined in claim 1, wherein the resource is a physical resource or a logical resource.

3. A method as defined in claim 1, further including utilizing a presence protocol to implement the situation stream.

4. A method as defined in claim 1, wherein the monitoring information is first monitoring information, the method further including:
monitoring the situation stream for a message including a resource identifier and an alert type;
in response to detecting a message including the resource identifier and the alert type:
identifying second monitoring information based on the resource identifier and the alert type; and
transmitting the identified second monitoring information to the situation stream.

5. A method as defined in claim 4, wherein the resource is a first resource and the monitoring information is first monitoring information, the method further including:
identifying third monitoring information for a second resource related to the first resource in the computing environment; and
transmitting the third monitoring information to the situation stream.

6. A method as defined in claim 5, wherein the management application manages the first resource and the second resource.

7. A method as defined in claim 4, further including:
determining whether an administrator accessing the situation stream is entitled to access the monitoring information based on the alert type; and
when the administrator is not entitled to access the monitoring information, logging the monitoring information in a queue.

8. A method as defined in claim 4, wherein the management application is a first management application, the method further including:
detecting the message including the resource identifier and the alert type at a second management application, the second management application in communication with the situation stream, and
wherein the resource is managed by the first management application and the second management application.

9. An apparatus to manage operational situations in a computing environment, the apparatus comprising:
a resources handler to determine monitoring information of a resource managed by the apparatus in the computing environment;
an alarm manager to compare the monitoring information to a policy associated with the resource; and
a connector module to post an alert message to a situation stream in communication with the apparatus based on the comparison, the alert message to include an identifier associated with the resource.

10. An apparatus as defined in claim 9, wherein the resource is a physical resource or a logical resource.

11. An apparatus as defined in claim 9, wherein the connector module is to utilize a presence protocol to implement the situation stream.

12. An apparatus as defined in claim 9, wherein the monitoring information is first monitoring information, the apparatus further including:
an information retriever to identify second monitoring information based on a resource identifier and an alert type included in a message detected in the situation stream; and
the connector module to transmit the identified second monitoring information to the situation stream.

13. An apparatus as defined in claim 12, wherein the resource is a first resource and the monitoring information is first monitoring information, the information retriever is to identify third monitoring information for a second resource related to the first resource in the computing environment, and the connector module is to transmit the third monitoring information to the situation stream.

14. An apparatus as defined in claim 13, further including a resources handler to manage the first resource and the second resource.

15. An apparatus as defined in claim 12, further including an entitlement manager to:
determine whether an administrator accessing the situation stream is entitled to access the monitoring information based on the alert type; and
log the monitoring information in a queue when the administrator is not entitled to access the monitoring information.

16. An apparatus as defined in claim 12, wherein the apparatus is a first apparatus, wherein the connector module is to detect the message including the resource identifier and the alert type posted by a second apparatus in communication with the situation stream, the resource to be managed by the first apparatus and the second apparatus.

17. A tangible computer readable storage medium comprising instructions that, when executed, cause a machine to at least:
determine monitoring information of a resource managed by a management application in a computing environment, the resource to be a physical resource or a logical resource;
compare the monitoring information to a policy associated with the resource; and
post an alert message to a situation stream in communication with the management application when the monitoring information fails to satisfy the policy, the alert message to include an identifier associated with the resource.

18. A tangible computer readable storage medium as defined in claim 17, wherein the instructions, when executed, cause the machine to utilize a presence protocol to implement the situation stream.

19. A tangible computer readable storage medium as defined in claim 17, wherein the monitoring information is first monitoring information, and wherein the instructions, when executed, cause the machine to:
monitor the situation stream for a message including a resource identifier and an alert type;
in response to detection of a message including the resource identifier and the alert type:
identify second monitoring information based on the resource identifier and the alert type; and
transmit the identified second monitoring information to the situation stream.

20. A tangible computer readable storage medium as defined in claim 19, wherein the resource is a first resource and the monitoring information is first monitoring information, and wherein the instructions, when executed, cause the machine to:
identify third monitoring information for a second resource related to the first resource in the computing environment, the first resource and the second resource to be managed by the management application; and
transmit the third monitoring information to the situation stream.

21. A tangible computer readable storage medium as defined in claim 19, wherein the instructions, when executed, cause the machine to:
determine whether an administrator accessing the situation stream is entitled to access the monitoring information based on the alert type; and
log the monitoring information in a queue when the administrator is not entitled to access the monitoring information.

22. A tangible computer readable storage medium as defined in claim 19, wherein the management application is a first management application, the instructions, when executed, cause the machine to detect the message including the resource identifier and the alert type at a second management application, the second management application in communication with the situation stream, and the resource is managed by the first management application and the second management application.
